(19) United States
(12) Patent Application Publication
(10) Pub. No.: US 2006/0247912 A1
(43) Pub. Date: Nov. 2, 2006

(54) Metric for evaluating systems that produce text

(75) Inventors: Hisami Suzuki, Redmond, WA (US); Jianfeng Gao, Beijing (CN)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/115,498

(22) Filed: Apr. 27, 2005

(51) Int. Cl. G06F 17/20

(52) U.S. Cl. 704/1

(57) ABSTRACT

A method and apparatus for generating a score for a system that generates text is provided. The method and apparatus identify errors in the text generated by the system and identify errors in a second text generated by a second system. The number of errors that are generated by the system but not generated by the second system is divided by the number of errors that are generated by the second system but not by the system to generate the score.

### BACKGROUND OF THE INVENTION

The present invention relates to evaluating models and algorithms. In particular, the present invention relates to evaluating models and algorithms that produce text.

There are several types of systems that produce text as an output. For example, speech recognition systems convert acoustic signals into text. In pinyin-to-character conversion systems, phonetic strings, known as pinyin, that describe the pronunciation of Chinese words are converted into Chinese characters. In Kana-Kanji conversion systems, Kana characters that represent the phonetics of Japanese words are converted into a string of Kanji characters. In spell checking systems, an improperly spelled text is converted into a properly spelled text. In machine translation systems, a sequence of characters in a first language is converted into a sequence of characters in a second language. In annotation systems, a text is tagged with textual annotations such as part-of-speech tags. In information retrieval systems, a text is returned based on a query.

The models or algorithms used in these systems are updated from time to time in order to try to reduce the number of errors produced in the output text. In the past, the performance of the models or algorithms has been measured based on the absolute number of errors in the output text.

Unfortunately, when changing a model or an algorithm, it is possible to introduce side effects, which are new errors that were not present in the previous model or algorithm. As a result, even if a new model or algorithm produces fewer errors, it may introduce a new error that was not present before.

In the prior art, it has not been possible to measure the relative performance of a new model in such a way so as to take into account side effects introduced by the model. Therefore, a new metric is needed for comparing new models and algorithms to previous models and algorithms that produce output text.

### SUMMARY OF THE INVENTION

A method and apparatus for generating a score for a system that generates text is provided. The method and apparatus identify errors in the text generated by the system and identify errors in a second text generated by a second system. The number of errors that are generated by the system but not generated by the second system is divided by the number of errors that are generated by the second system but not by the system to generate the score.

### BRIEF DESCRIPTION OF THE DRAWINGS

FIG. 1 is a block diagram of one computing environment in which the present invention may be practiced.

FIG. 2 is a block diagram of an alternative-computing environment in which the present invention may be practiced.

FIG. 3 is a flow diagram of a method of forming a metric under one embodiment of the present invention.

FIG. 4 is a block diagram of elements used to form a metric under one embodiment of the present invention.

FIG. 5 is a graph showing the performance of various models as a function of error ratio and relative error reduction.

FIG. 6 is a graph showing changes in error rate as a function of the number of iterations of training.

### DETAILED DESCRIPTION OF ILLUSTRATIVE EMBODIMENTS

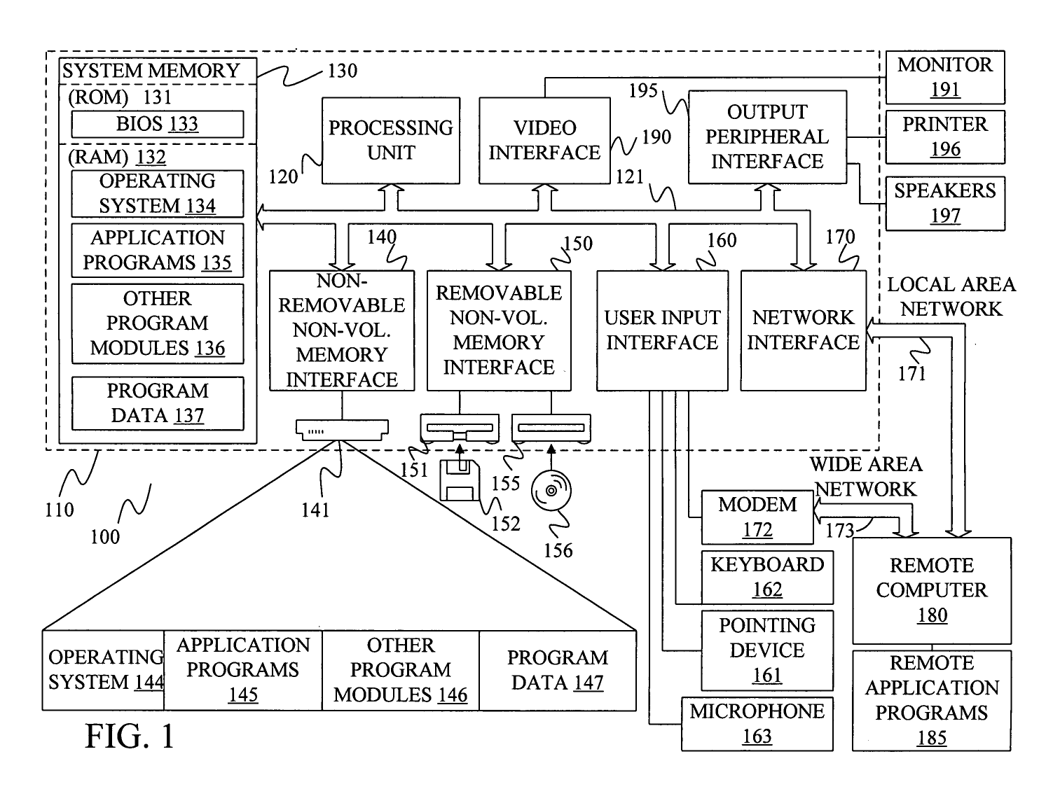

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention is designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

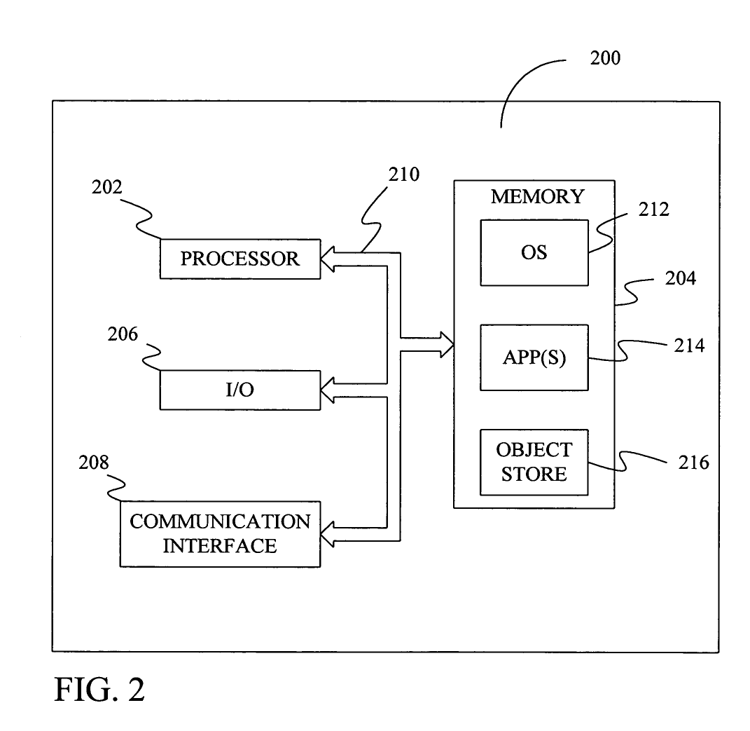

FIG. 2 is a block diagram of a mobile device 200, which is an exemplary computing environment. Mobile device 200 includes a microprocessor 202, memory 204, input/output (I/O) components 206, and a communication interface 208 for communicating with remote computers or other mobile devices. In one embodiment, the afore-mentioned components are coupled for communication with one another over a suitable bus 210.

Memory 204 is implemented as non-volatile electronic memory such as random access memory (RAM) with a battery back-up module (not shown) such that information stored in memory 204 is not lost when the general power to mobile device 200 is shut down. A portion of memory 204 is preferably allocated as addressable memory for program execution, while another portion of memory 204 is preferably used for storage, such as to simulate storage on a disk drive.

Memory 204 includes an operating system 212, application programs 214 as well as an object store 216. During operation, operating system 212 is preferably executed by processor 202 from memory 204. Operating system 212, in one preferred embodiment, is a WINDOWS® CE brand operating system commercially available from Microsoft Corporation. Operating system 212 is preferably designed for mobile devices, and implements database features that can be utilized by applications 214 through a set of exposed application programming interfaces and methods. The objects in object store 216 are maintained by applications 214 and operating system 212, at least partially in response to calls to the exposed application programming interfaces and methods.

Communication interface 208 represents numerous devices and technologies that allow mobile device 200 to send and receive information. The devices include wired and wireless modems, satellite receivers and broadcast tuners to name a few. Mobile device 200 can also be directly connected to a computer to exchange data therewith. In such cases, communication interface 208 can be an infrared transceiver or a serial or parallel communication connection, all of which are capable of transmitting streaming information.

Input/output components 206 include a variety of input devices such as a touch-sensitive screen, buttons, rollers, and a microphone as well as a variety of output devices including an audio generator, a vibrating device, and a display. The devices listed above are by way of example and need not all be present on mobile device 200. In addition, other input/output devices may be attached to or found with mobile device 200 within the scope of the present invention.

The present invention provides a new metric that allows more useful comparison of the performance of an existing model to a new model. This metric is formed based on the number of new errors produced by the new model and the number of errors produced by the exiting model that are corrected by the new model.

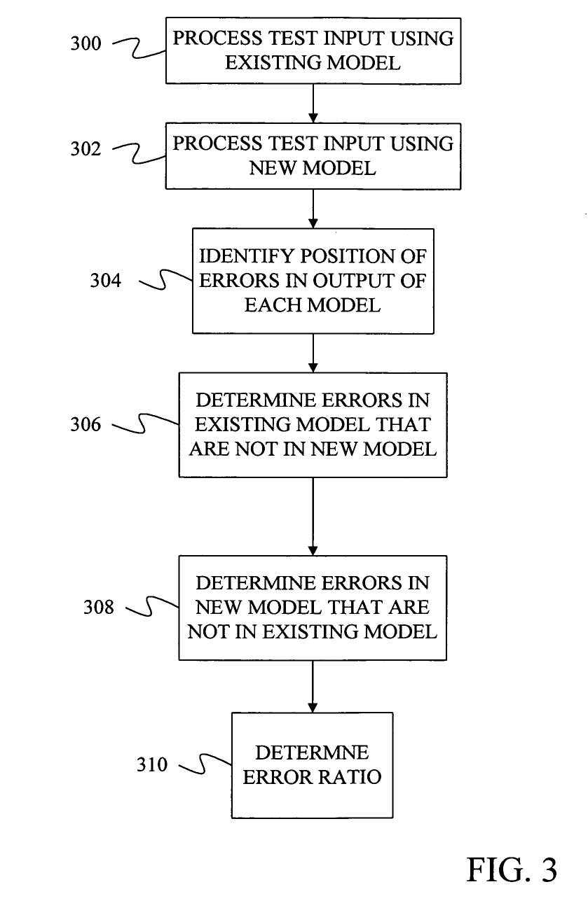

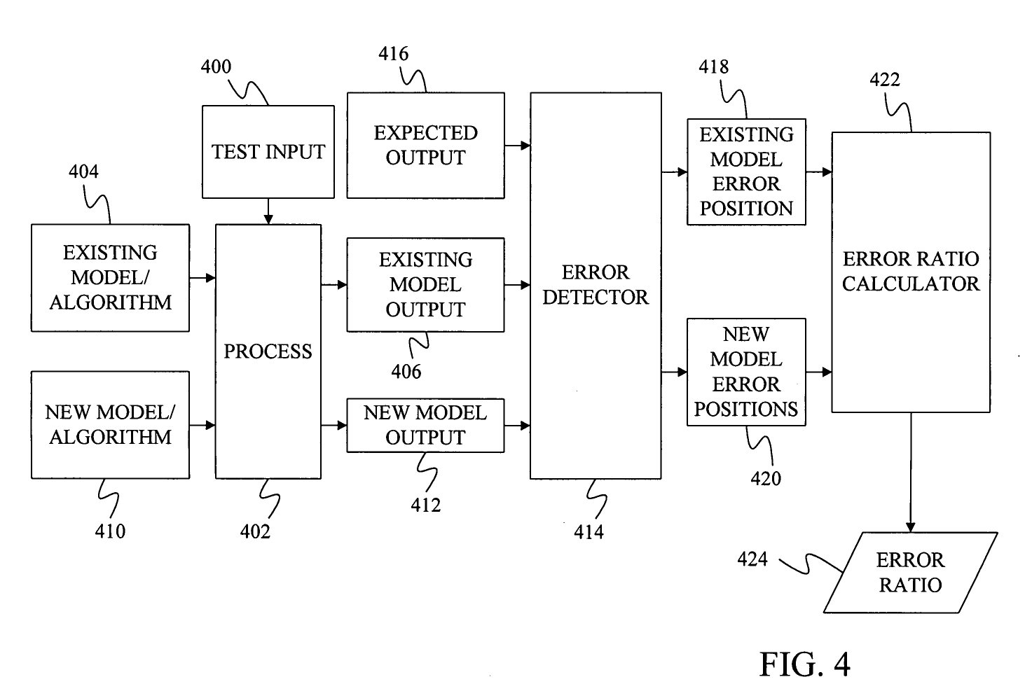

FIG. 3 provides a flow diagram for generating an error metric under embodiments of the present invention. FIG. 4 provides a block diagram of elements used in generating the error metric.

In step 300 of FIG. 3, a test input 400 is provided to a process 402, which uses an existing model/algorithm 404 to form an existing model output 406. For example, in Kana-Kanji conversion, the test input 400 would be a sequence of phonetic characters known as Kana and the existing model output would be a sequence of Japanese characters including Kana, Kanji and other scripts. In pinyin-to-character conversion, input 400 is a sequence of pinyin phonetic units and output 406 is a sequence of Chinese characters. In speech recognition, the test input 400 is values representing an acoustic signal and existing model output 406 is a sequence of characters decoded from the acoustic signal. In machine translation systems, test input 400 is a text in a first language and existing model output 406 is a text in a second language representing a translation from the text in the first language. For spell checking and grammar checking systems, the test input 402 would be text containing spelling/grammar errors and existing model output 406 would be text in which some of the spelling and/or grammar errors have been corrected.

At step 302 of FIG. 3, test input 400 is again applied to process 404, this time using new model/algorithm 410 to produce new model output 412. New model/algorithm 410 takes the place of existing model/algorithm 408 in process 404.

At step 304, an error detector 414 identifies the position of errors in existing model output 406 and new model output 412 using an expected output 416. Expected output 416 indicates the proper sequence of characters that should have been produced given test input 400. These errors can include deletion, insertion and substitution of characters that are found in the expected output 416. Based on this process, error detector 414 produces existing model error positions 418 and new model error positions 420. Under some embodiments, the errors are also tagged with weights so that different errors can be weighted differently according to their severity.

At step 306, an error ratio calculator 422 determines the number of errors that are present in existing model output 406 that are not present in new model output 412 using existing model error positions 418 and new model error positions 420. This number represents the number of errors corrected by the new model. An error that is found in both the existing model and the new model is not counted. For embodiments that apply different weights to different errors, the weights of the errors are summed instead of simply counting the errors. At step 308, error ratio calculator 422 determines the number of errors in new model output 412 that are not present in existing model output 406 using existing model error positions 418 and new model error positions 420. This represents the number of side effect or new errors introduced by the new model. Again, for embodiments that apply different weights to different errors, the weights of the errors are summed instead of just counting the errors.

At step 310, error ratio calculator 422 determines an error ratio 424 by dividing the number of errors in new model output 412 that are not present in existing model output 406 by the number of errors in existing model output 406 that are not present in new model output 412. Thus, the error ratio is determined as:

$$ER = \frac{\vert {E}_{A} \vert}{\vert {E}_{B} \vert} \qquad EQ . 1$$

where ER is the error ratio, |E_{A}| is the number of errors found in only new model output 412, and |E_{B}| is the number of errors found only in existing model output 406. Note that in other embodiments, the inverse of ER can be used as the metric. Similarly, log-based values may be calculated to form the metric using |E_{A}| and |E_{B}|. In embodiments were different errors have different weights, |E_{A}| is the sum of the weights for the errors found only in new model output 412 and |E_{B}| is the sum of the weights for the errors found only in existing model output 406.

The error ratio of EQ. 1 can be viewed as the ratio of the number of new errors introduced by the new model over the number errors corrected by the new model that had been present in the existing model.

The error ratio provides a strong metric for indicating the side effects associated with a new model relative to an existing model. In particular, if the error ratio is greater than 1, the new model creates more new errors than it corrects and thus should not be adopted over the existing model. Error ratios that are less than 1 indicate that the new model corrects more errors than it introduces. In general, new models that have lower error ratios perform better than models with higher error ratios. A new model with an error ratio of 0, for instance, indicates that the new model corrects at least 1 error in the existing model while not introducing any new errors.

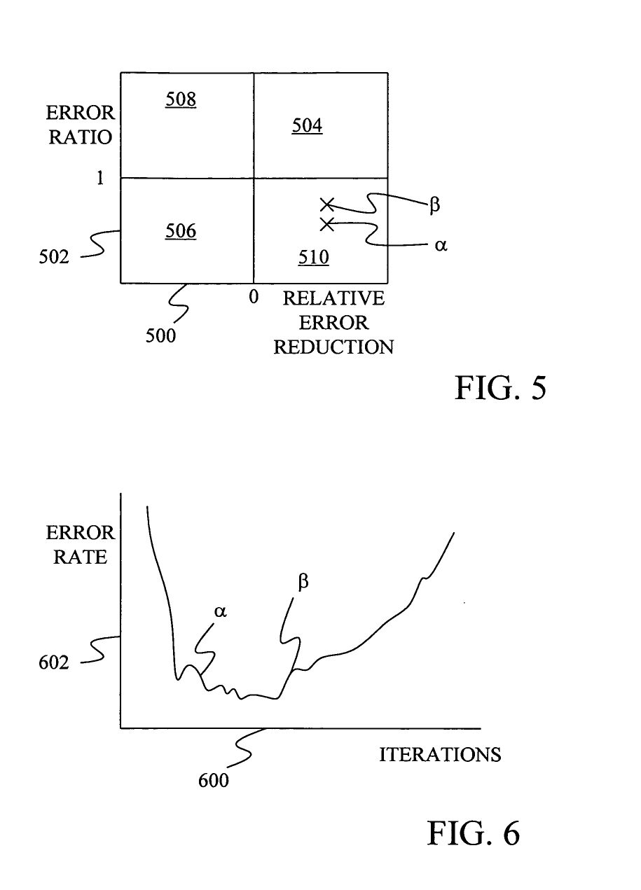

FIG. 5 provides a graph showing relative error reduction along horizontal axis 500 and error ratio along vertical axis 502. Relative error reduction is the difference between the number of errors in the existing model and the number of errors in the new model shown as a percentage. Although relative error reduction is shown in FIG. 5, the error ratio of the present invention may be plotted against any other known metric for measuring the performance of models.

In FIG. 5, there are four quadrants shown with an axis point of 0 for the relative error reduction and 1 for the error ratio. The upper right quadrant 504 and the lower left quadrant 506 are logically impossible. New models that provide relative error reductions and error ratios in upper left quadrant 508 introduce more errors than they correct relative to the existing model. New models that provide relative error reduction and error ratios found in lower right quadrant 510 provide fewer errors than are found in the existing model. In general, new models are believed to perform better if they are as far right and as far down as possible in the graph of FIG. 5.

Using the error ratio, it is possible to make a more informed decision as to which of two new models to select. In particular, although a new model may have more relative error reduction, if its error ratio is too high, it may be undesirable to adopt the new model since it may cause the system to generate new errors where the system had not produced errors in the past. For example, in a spelling system, a system may not correctly identify the spelling of a word that it had previously been able to identify. Introducing such new errors into a system is undesirable since it frustrates users and causes them to lose confidence in the system.

The error metric of the present invention can also be used to identify when a model has been over trained. FIG. 6 provides a draft showing training iterations along horizontal axis 600 and character error rates along vertical axis 602. As can be seen in FIG. 6, as the number of iterations of training applied to a model increases, the number of character errors initially begins to decrease. However, after more iterations, the number of errors begins to increase. This increase is caused by over-fitting the model to the training data used to set the model parameters. In effect, the model becomes too specialized and too directed toward the small set of training data used to set the model parameters.

In the past, it has been difficult to provide a metric that would indicate which of two sets of model parameters should be selected when both model parameters provide the same character error rate. For example, in FIG. 6, point α and point β refer to two different sets of model parameters that have the same character error rate. Thus, using character error rate alone, it is not possible to select which of these two models to implement. However, when an error ratio is determined for these two models, it is found that the error ratio of the α point is lower than the error ratio of the β point. This can be seen in FIG. 5. Thus, using the error ratio, it is possible to identify that the model parameters associated with point α will provide a better result than the model parameters at point β, thus confirming that the model parameters associated with point β suffer from over-fitting or over training.

As described above, the present invention provides a new metric known as the error ratio for measuring the relative performance of a new model to an existing model to determine whether the new model should be implemented in place of the existing model. In addition, the new metric can be used to determine the performance of two separate new models relative to a base model. Using the error ratios of the two new models, one of the new models can be selected over the other new model.

Although the present invention has been described with reference to particular embodiments, workers skilled in the art will recognize that changes may be made in form and detail without departing from the spirit and scope of the invention.

What is claimed is:

1. A method of generating a metric for measuring the performance of a first system that produces a first text from an input relative to the performance of a second system that produces a second text from the input, the method comprising:
comparing the first text to an expected text to identify errors in the first text;
comparing the second text to the expected text to identify errors in the second text;
using the number of errors that are in the first text but are not in the second text and the number of errors that are in the second text but are not in the first text to form the metric.

2. The method of claim 1 wherein forming the metric comprises dividing the number of errors that are in the first text but are not in the second text by the number of errors that are in the second text but are not in the first text.

3. The method of claim 1 wherein the first system is adapted from the second system by further training parameters of the second system.

4. The method of claim 3 wherein further training the parameters of the second system to form the parameters of the first system comprises performing further training iterations.

5. The method of claim 1 wherein the first system forms the first text from an input comprising a sequence of phonetic units.

6. The method of claim 1 wherein the first system is a speech recognition system.

7. The method of claim 1 wherein the first system is a machine translation system.

8. The method of claim 1 wherein the first system is a grammar checker.

9. A computer-readable medium having computer-executable instructions for performing steps comprising:
determining a number of new errors, the number of new errors being the number of errors in a first text formed from a first model that are not present in a second text formed from a second model;
determining a number of corrected errors, the number of corrected errors being the number of errors in the second text formed from the second model that are not present in the first text formed from the first model; and
using the number of new errors and the number of corrected errors to measure the performance of the first model relative to the second model.

10. The computer-readable medium of claim 9 wherein using the number of new errors and the number of corrected errors comprises dividing the number of new errors by the number of corrected errors.

11. The computer-readable medium of claim 9 wherein the first model is adapted from the second model.

12. The computer-readable medium of claim 11 wherein the performance of the first model is used to determine if the first model has been over-fit to training data.

13. The computer-readable medium of claim 9 having computer-executable instructions for performing further steps comprising:
determining a second number of new errors, the second number of new errors being the number of errors in a third text formed from a third model that are not present in the second text formed from the second model;
determining a second number of corrected errors, the second number of corrected errors being the number of errors in the second text formed from the second model that are not present in the third text formed from the third model;
using the second number of new errors and the second number of corrected errors to measure the performance of the third model relative to the second model; and
comparing the performance of the first model to the performance of the third model.

14. The computer-readable medium of claim 9 wherein the first text is formed based on an input sequence of Pinyin.

15. The computer-readable medium of claim 9 wherein the first text is formed based on an input sequence of Kana.

16. A method of generating a score for a system that generates a text, the method comprising:
identifying errors in the text generated by the system;
identifying errors in a second text generated by a second system;
dividing the number of errors that are generated by the system but not generated by the second system by the number of errors that are generated by the second system but not by the system to generate the score.

17. The method of claim 16 wherein identifying errors in the text comprises marking the position of errors in the text.

18. The method of claim 16 wherein the system converts a sequence of phonetic units into the text.

19. The method of claim 16 further comprising using the score to determine if the system is over trained.

20. The method of claim 16 further comprising including the system as part of a software package based at least in part on the score for the system.
